(19) United States
(12) Patent Application Publication
(10) Pub. No.: US 2006/0202370 A1
(43) Pub. Date: Sep. 14, 2006

(54) Method for controlling the production of injection molded parts

(76) Inventor: Christopherus Bader, Neftenbach (CH)

Correspondence Address: BACHMAN & LAPOINTE, P.C., 900 CHAPEL STREET, SUITE 1201, NEW HAVEN, CT, 06510, US

(21) Appl. No.: 10/540,432

(22) PCT Filed: Dec. 22, 2003
(86) PCT No.: PCT/EP03/14715

§ 371 Date: Dec. 23, 2005

(30) Foreign Application Priority Data
Dec. 23, 2002 (DE) 102 61 498.9

(51) Int. Cl. B29C 45/76; B29C 45/78; B29C 45/73

(52) U.S. Cl. 264/40.1; 264/40.6; 264/328.16; 264/408; 425/547

(57) ABSTRACT

A method for controlling the production of injection molded parts in an injection molding die, which comprises a cavity and, optionally, a mold core of an injection molding machine, during which the temperature of the die is controlled. In addition, the cavity and/or the mold core are/is directly heated or cooled.

The invention relates to a method for controlling the production of injection-molded parts in an injection mold of an injection molding machine with a cavity and possibly a mold core, the temperature of the mold being controlled, and also to an injection molding machine for this.

### PRIOR ART

In the case of known methods for filling a mold, for example with thermoplastic materials, the filling operation is controlled in such a way that an initial speed-controlled phase is followed by a pressure-controlled phase, which lasts until the end of the filling operation. Toward the end of the speed-controlled phase or in the initial period of the pressure-controlled phase, the filling situation in which the mold cavity is completely wetted with plasticizable compound is reached, the pressure of the compound inside the mold cavity still being comparatively low. As a result of a continuation of the movement of an injection plunger or an extruder, this is followed by an increase in the internal mold pressure, accompanied by a reduction in the specific volume or an increase in the density of the molding compound located in the mold cavity. The extent of the compaction which can be achieved in this way depends not only on the prevailing temperature but also on the level of the pressure acting and the characteristic properties of the molding compound.

Once the supply of melt to the mold cavity has stopped, the melt begins to solidify in the sprue. This seals the mold cavity and no further polymer melt can be supplied. The temperature in the mold cavity falls, until the 1 bar isochore is reached. Then the molded part begins to shrink, until the molded part has reached room temperature.

The shrinking of the molded part is determined by the pressure and temperature conditions and also in particular by the viscosity of the melt in the cavity. A major factor for the shrinkage of the molded parts is the temperature distribution in the cavity at the end of the filling phase (or the pressure maximum) until the end of the cycle. A different shrinkage from cycle to cycle results from the variation of the temperature profile and the variation of the internal mold pressure profile.

This applies both to single-cavity molds and to multi-cavity molds. In the production of injection-molded parts of all kinds (plastic, metal, ceramic, etc.), a number of parts per cycle are often simultaneously produced for reasons of cost (multi-cavity mold). In this case, the individual cavities are normally balanced with respect to their geometry and feed points to the extent that the most uniform possible quality of the injection-molded parts is achieved. In reality, however, the shrinkage behavior of the individual injection-molded parts always differs and changes constantly on the basis of the material, variations in temperature and resultant variations in viscosity.

DE 101 14 228 A discloses for example a method of obtaining a more uniform shrinkage behavior of an injection-molded part both between individual cavities of a multi-cavity mold and from cycle to cycle of an injection molding operation. In this case, the temperature and/or an internal pressure in the cavity is monitored and made to match a reference profile by temperature control of the mold from the end of the filling phase or from a pressure maximum in the cavity to the end of the injection cycle.

### OBJECT

The present invention is based on the object of presenting further possibilities for obtaining more uniform production of injection-molded parts in a simple way and possibly controlling it to obtain certain properties—such as for example a certain dimension.

### SOLUTION ACHIEVING THE OBJECT

This object is achieved by directly heating or cooling the cavity and/or the mold core.

While previously the shrinkage behavior of an injection-molded part has only been controlled with the aid of the internal mold pressure and the temperature of the mold wall by adapting the temperature control of one or more cooling circuits on the basis of the temperature of the cooling medium, now the temperature of the cavity or the mold core is directly influenced. For this purpose, the cavity or the mold core is directly assigned heating elements or cooling elements. It is also conceivable for the cavity and/or the mold core to be coated with a thermo-ceramic coating, which is known by the name “thermoceramix”.

By means of these heating elements or heatable coatings, the cavity or the mold core is directly heated to a desired temperature. Excess heat can be removed by one or more temperature control circuits.

By analogy, methods with the reverse principle (hot mold/cold melt), such as for example the injection molding of thermosetting materials, elastomers and silicone melts, can be controlled with the aid of heat-removing methods in such a way that the pressure and temperature conditions in the cavity or cavities remain constant. For this purpose, cooled mold cores or else heat-removing metal inserts or coatings may be used for example.

In a further exemplary embodiment, it is considered to create a closed control loop, including optical viewing of the injection-molded part produced. Irrespective of the type of control of the injection molding machine, for example controlling the injection parameters, controlling the temperature medium, the heating elements or the heat removal, the closed control loop can be extended to the extent that one or more dimensions of one or more injection-molded parts and, under some circumstances, the surface finish or color of the injection-molded parts are additionally measured with the aid of an optical instrument, preferably outside the mold, and included in the control process. This has the advantage that control not only takes place relatively on the basis of constant pressure and temperature conditions but also absolutely on the basis of specific part dimensions, or possibly on the basis of a specific surface finish.

For the sake of simplicity, the optical recording instrument should be arranged outside the mold or the production area, or outside the injection molding machine, where the injection-molded part or parts can be positioned and “scanned” with the aid of a handling system. A scanner or a CCD camera come into consideration for example as the instrument.

This control principle on the one hand offers cost advantages over the known visual monitoring systems (monitoring cameras), and can also be installed without personnel supervision. The servicing involved is significantly less and it is also conceivable as an OEM product. Handling/removal devices are today already in widespread use in the injection molding process, so that additional optical monitoring can be integrated without any great additional expenditure.

### DESCRIPTION OF FIGURES

Further advantages, features and details of the invention emerge from the description of preferred exemplary embodiments which follows and on the basis of the drawing, in which:

FIG. 1 shows a schematically represented side view of an injection molding machine according to the invention;

FIG. 2 shows a schematically represented side view of a further exemplary embodiment of an injection molding machine.

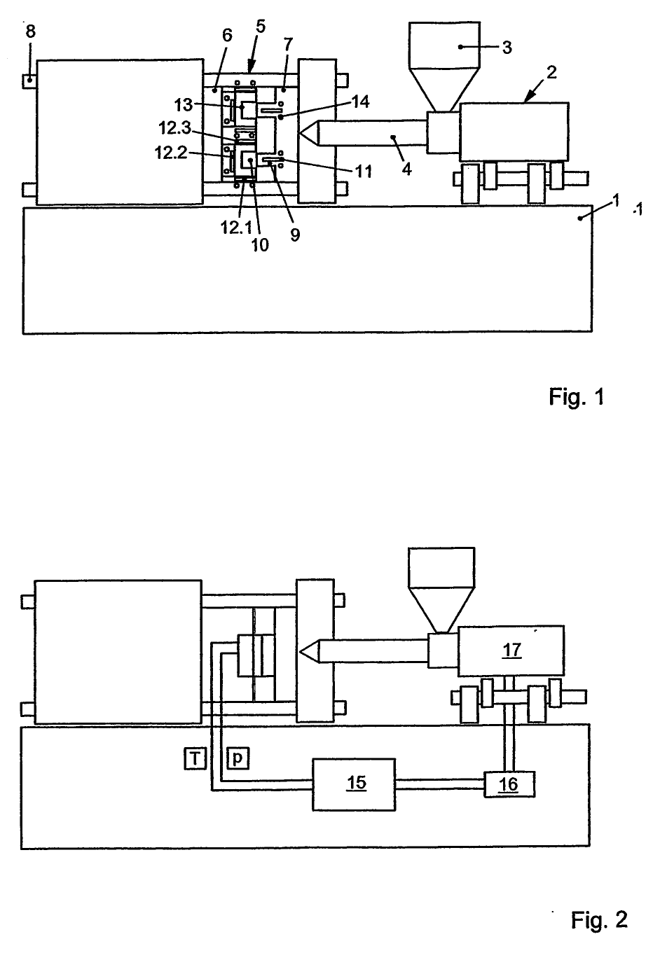

On a factory floor 1 for example there is an extruder unit 2, polymer passing from an accumulator 3 into a screw 4. From the screw 4, the polymer is forced into runners (not shown in any more detail) of an injection mold 5. The injection mold 5 has a fixed platen 6 and a movable platen 7. Both platens 6 and 7 are guided on guiding tie bars 8.

On the movable platen 7 there are mold cores 9, which interact with cavities 10 in the fixed platen 6, in order to form a mold cavity for producing an injection-molded part (not shown in any more detail). According to the invention, heating elements 11 are provided in the mold core 9. Likewise, three heating elements 12.1 to 12.3 are assigned to the cavity 10. It is also indicated that the interior of the cavity 10 is provided with a thermoceramic coating 13, which may be located not only on the surface but also under the surface and behind the mold insert.

Both in the fixed platen 6 and in the movable platen 7 there is at least one cooling circuit 14.

The operating principle of the injection molding machine according to the invention is as follows:

The basic idea of the invention is that the temperature of a cavity or a mold core is not only controlled by means of the cooling circuits, and there on the basis of the temperature of the cooling medium, but with the aid of the heating elements. If it is established that the cavity or mold core is at too low a temperature, the heating elements are controlled to operate at a higher level. If, on the other hand, it is established that the temperature in the cavity or on the mold core is too high, the excess heat is removed by the cooling circuit. For example, for this purpose the circulation in the cooling circuit is increased or the temperature of the cooling medium is lowered.

The aim is to keep the pressure and temperature conditions in the cavity or cavities 10 constant.

On the reverse principle (hot mold/cold melt), the injection molding of thermosetting materials, elastomers and silicone melts can also be controlled with the aid of heat-removing methods. For this purpose, cooled mold cores or heat-removing metal inserts may be used instead of the heating elements.

In FIG. 2, a further method according to the invention is indicated. This involves a closed control loop, the pressure p and the temperature T in the mold cavity being determined. Furthermore, the injection-molded part itself is assessed by means of an instrument 15. For example, the instrument 15 records the dimension of the injection-molded part, its surface finish or else its color, the corresponding values passing to a control 16 and being compared there with stored reference values, in just the same way as the temperature and the pressure in the cavity. On the basis of the result of this comparative consideration, a corresponding signal emission then takes place to a machine control 17, with which in turn the injection molding process and in particular the temperature of the melt and the platens and the injection pressure are controlled. Consequently, a control process takes place not only relatively on the basis of constant pressure and temperature conditions but also absolutely on the basis of certain characteristics of the injection-molded parts.

1. A method for controlling the production of injection-molded parts in an injection mold (5) with a cavity (10) and possibly a mold core (9) of an injection molding machine, the temperature of the mold (5) being controlled, characterized in that the cavity (10) and/or the mold core (9) is/are directly heated or cooled.

2. The method as claimed in claim 1, characterized in that excess heat is removed by one or more cooling circuits (14) in the mold (5).

3. A method for controlling the production of injection-molded parts in an injection mold (5), characterized in that the injection-molded part is at least partly optically viewed with corresponding instruments (15) in a control loop and the result of the viewing is compared with references and signals for a machine control (17) are derived from this.

4. The method as claimed in claim 3, characterized in that the dimension and/or the surface finish and/or the color of the injection-molded part is/are determined.

5. The method as claimed in claim 3, characterized in that the determination takes place with a scanner, a CCD camera or the like.

6. The method as claimed claim 3, characterized in that pressure and temperature values (p, T) in the cavity (10) are included in the control process.

7. An injection molding machine for producing injection-molded parts in an injection mold (5) with a cavity (10) and possibly a mold core (9), characterized in that the cavity (10) and/or the mold core (9) are assigned heating or cooling elements (11, 12.1-12.3) or the cavity (10) and/or the mold core (9) has a thermoceramic coating (13).

8. The injection molding machine as claimed in claim 7, characterized in that one or more temperature control circuits (14) are provided in the injection mold (5).

9. An injection molding machine for producing injection-molded parts in an injection mold (5) with a cavity (10) and possibly a mold core (9), characterized in that the injection mold (5) is assigned an instrument (15) for optically viewing the injection-molded part and said instrument is connected to a control (16) comprising reference values, which operates a machine control (17).
